(19) United States
(12) Patent Application Publication
(10) Pub. No.: US 2007/0055859 A1
(43) Pub. Date: Mar. 8, 2007

(54) BOOT SYSTEMS AND METHODS

(75) Inventors: Tzung-Shian Yang, Ilan County (TW); Ching-Lin Hsu, Taichung County (TW); Chih-Chuan Huang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/381,174

(22) Filed: May 2, 2006

Related U.S. Application Data
(60) Provisional application No. 60/713,978, filed on Sep. 2, 2005.

(51) Int. Cl. G06F 9/00; G06F 15/177

(52) U.S. Cl. 713/2

(57) ABSTRACT

Boot systems and methods. A processing unit decrypts a first ciphertext in first memory to generate a first plain text comprising a jump instruction of a first specific address of the first memory, stores the first plain text at a first address of second memory, and executes the first plain text at the first address. The processing unit decrypts a second ciphertext in the first memory to generate a second plain text, stores the second plain text at a second address of the second memory, and executes the second plain text at the second address. A boot procedure of the device proceeds after the execution of the second plain text.

### BACKGROUND OF THE INVENTION

1. Field of the Invention

The present disclosure relates generally to boot management, and more particularly to systems and methods that securely boot an electronic device.

2. Description of the Related Art

The integrity and security of electronic devices, such as embedded systems, are important industry goals. Since the stability of electronic devices depends largely on firmware or software therein, the electronic devices are stable if the firmware or software matches the hardware model and runs smoothly. The firmware or software, however, can be easily modified, or the non-volatile memory storing firmware or software replaced, such that related verification of the electronic devices can be skipped, affecting the stability of electronic devices.

Conventionally, software checksum can be used to avoid loading incorrect registry data, ensuring the correctness of the registry and the stability of electronic devices. Checksum comparison is a form of redundancy check for error detection, protecting the integrity of data, and ensuring the data is the same as original. In redundancy check, additional data is added to original data for the purposes of error detection and error correction. In checksum calculation, the basic components of data, typically the bytes are added up and stored. The same operation can be performed, and the result can be compared to the pre-calculated checksum value. If match, it is assumed that the data was probably not corrupted. If not, it is assumed that the data has been garbled. However, no mechanism is provided to avoid firmware or software tampering with resulting decrease in integrity of electronic devices.

### BRIEF SUMMARY OF THE INVENTION

Boot systems and methods are provided.

An embodiment of a boot system comprises first memory comprising first and second ciphertext, second memory, and a processing unit. The processing unit decrypts the first ciphertext to generate a first plain text, stores the first plain text at a first address of the second memory, and executes the first plain text at the first address. The processing unit decrypts the second ciphertext to generate a second plain text, and stores the second plain text at a second address of the second memory. The processing unit executes the second plain text at the second address. The processing unit proceeds with a boot procedure after the execution of the second plain text.

In an embodiment of a boot method, a first ciphertext in first memory is decrypted to generate a first plain text, and the first plain text is stored at a first address of second memory. The first plain text at the first address is executed. The second ciphertext is decrypted to generate a second plain text, and stores the second plain text at a second address of the second memory. The second plain text at the second address is executed. A boot procedure of the device proceeds with after the execution of the second plain text.

Boot systems and methods may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a boot system;

FIG. 2 is a flowchart of an embodiment of a method for storing the pre-calculated checksum in ciphertext/first ciphertext/second ciphertext;

FIG. 3 is a flowchart of an embodiment of a boot method;

FIG. 4 is a schematic diagram illustrating an embodiment of the memories;

FIG. 5 is a flowchart of another embodiment of a boot method;

FIG. 6 is a schematic diagram illustrating an embodiment of the memories;

FIG. 7 is a flowchart of still another embodiment of a boot method; and

FIG. 8 is a schematic diagram illustrating an embodiment of the memories.

### DETAILED DESCRIPTION OF THE INVENTION

Boot systems and methods are provided.

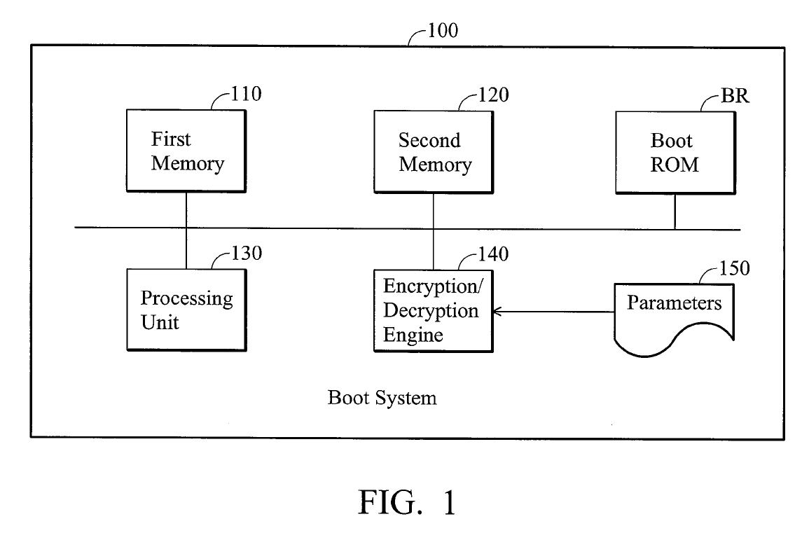

FIG. 1 is a schematic diagram illustrating an embodiment of a boot system.

The boot system 100 comprises boot ROM (read only memory) BR, defining steps and corresponding instructions for boot and verification. It is understood that the steps and corresponding instructions for boot and verification defined in the boor ROM cannot be skipped. The boot system 100 further comprises first memory 10, second memory 120, a processing unit 130, and a security engine 140. The boot system 100 can be used in a device such as an embedded system. The first memory 110 may be a flash memory, comprising first and second ciphertexts, and a pre-calculated checksum of the content in the first memory 110 in ciphertext. The content in the first memory 110 may comprises the first and second ciphertexts, and related instructions and data predefined therein. The checksum of the content in the first memory 110 can be calculated in advance. Similarly, in checksum calculation, the basic components of data, typically the bytes are added up and stored. The pre-calculated checksum can be encrypted in ciphertext to be pre-stored in the first memory 110. The encryption procedure is discussed later. The pre-calculated checksum in ciphertext can be used for integrity check, discussed later.

In some embodiments, the first ciphertext may comprise a jump instruction pre-stored in the Flash, and the second ciphertext is a short but essential predefined function, such as instructions for hardware initiation. The second memory 120 may be a RAM (random access memory). The processing unit 130 performs the boot methods of the invention. The security engine 140 decrypts the first and second ciphertext to obtain the first and second plain texts according to the parameters 150, respectively.

In some embodiments, parameters 150 can comprise identification, such as a chip ID (identification) of the device, a seed and a counter. The seed comprises date, time, circuit noise, and a random value. The counter may be a pure counter a counter with complicated algorithm, such as a LFSR (Linear Feedback Shift Registers) generating periodical pseudorandom bit sequences (PRBS), although it is understood that the parameters 150 are not limited thereto. In some embodiments, one of the parameters 150, such as the chip ID can be used in encryption, in which the security engine 140 receives a plain text checksum and the parameter, and uses the parameter as a key to encrypt the plain text checksum based on an encryption function, obtaining ciphertext checksum. In decryption, the security engine 140 receives the first ciphertext/second ciphertext together with a key, and uses the key to decrypt the first ciphertext/second ciphertext based on a decryption function, obtaining a first plain text/second plain text. It is understood that the ciphertext can be correctly decrypted to obtain the original plain text using the same key. If the key is not the same, the decrypted result cannot be the original plain text. In some embodiments, the encryption may be multiple inputs encryption, in which the security engine 140 receives a plain text checksum and the parameters 150 comprising the chip ID, a seed, or a counter, and uses the parameters as keys to encrypt the plain text checksum based on an encryption function, obtaining ciphertext checksum. In decryption, the security engine 140 receives the first ciphertext/second ciphertext together with keys, and uses the keys to decrypt the first ciphertext/second ciphertext based on a decryption function, obtaining a first plain text/second plain text. Similarly, the ciphertext can be correctly decrypted to obtain the original plain text using the same keys.

It should be known in the present invention, for integrity check, the boot system 100 calculates the checksum of the content in the first memory 110, and the security engine 140 encrypts the calculated checksum to be ciphertext checksum for being compared with the pre-calculated checksum in ciphertext. That is, a pre-calculated checksum is encrypted before to be stored in the first memory 10, and the keys/parameters for encrypting the pre-calculated checksum are the same as those in the boot system 100 for encrypting the calculated checksum.

Also, it should be known in the present invention, the original first/second plain text is also pre-encrypted before to be stored in the first memory 110, and similarly, the keys/parameters for encrypting the original first/second plain text are the same as those in the boot system 100 for decrypting the first ciphertext/second ciphertext stored in the first memory 110.

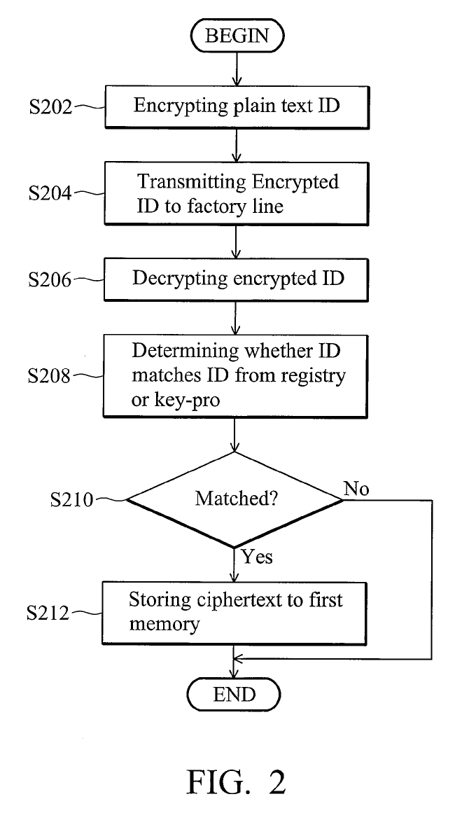

To increase the security of ciphertext and device, a security ID (identification) must be verified before the ciphertext, i.e. the pre-calculated checksum in ciphertext/the first ciphertext/the second ciphertext, is stored to the first memory in the factory line. FIG. 2 is a flowchart of an embodiment of a method for storing the pre-calculated checksum in ciphertext/first ciphertext/second ciphertext. In step S202, the original plain text of the security ID is encrypted during a build process. In step S204, the encrypted security ID is provided in the factory line, and in step S206, the encrypted security ID is decrypted to obtain a first plain text of the security ID. In step S208, it is determined whether the first plain text of the security ID matches a second plain text of the security ID loaded from a registry or key-pro, which is the same as the original plain text of the security ID. If matched (Yes in step S210), in step S212, the ciphertext is stored to the first memory. If not (No in step S210), storage of ciphertext is denied.

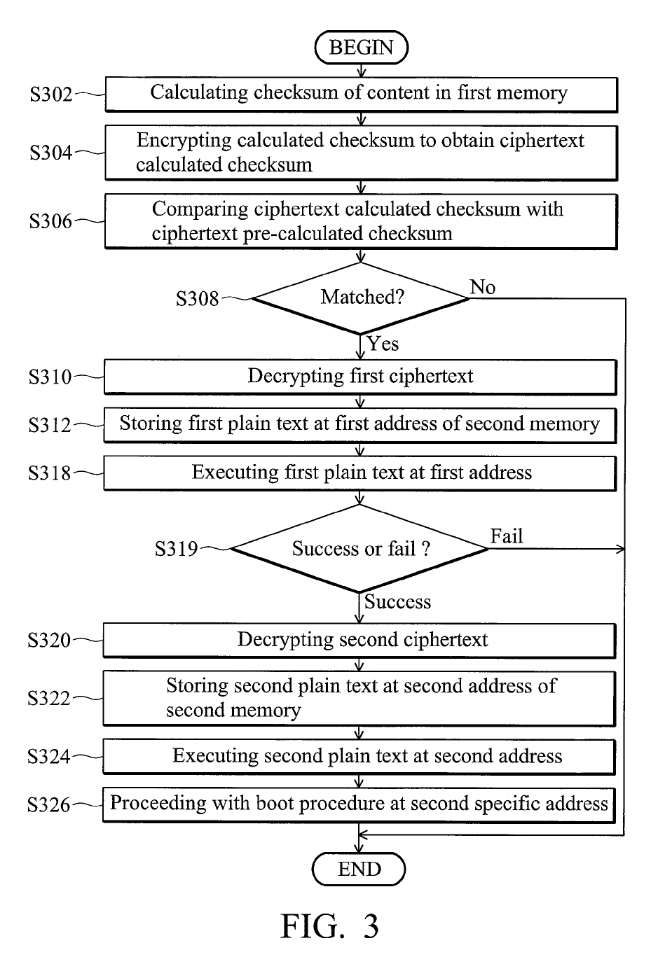

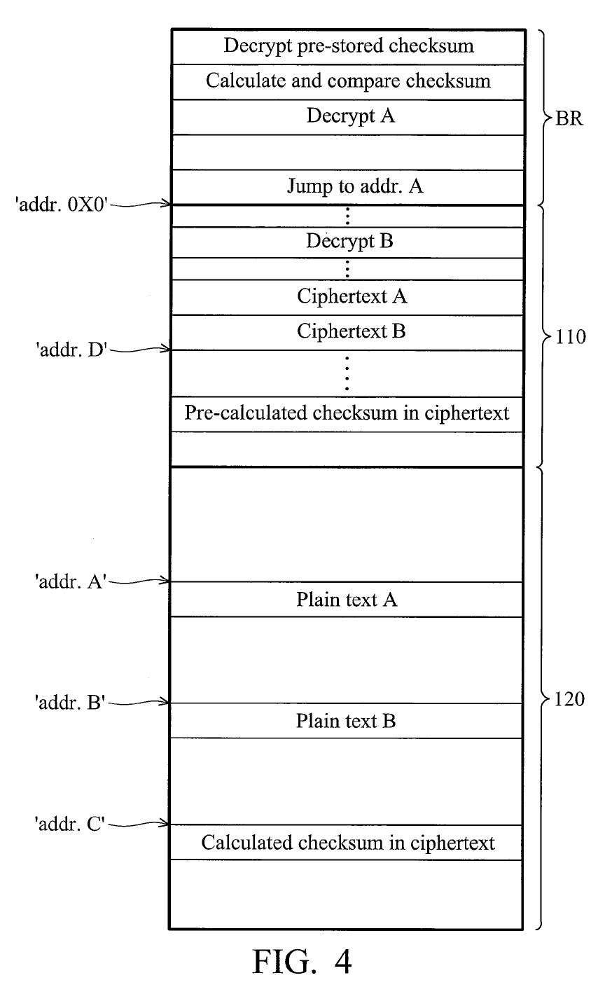

FIG. 3 is a flowchart of an embodiment of a boot method, in which the first and second ciphertexts and the pre-calculated checksum in ciphertext are stored to the first memory in the factory line via the mentioned method for storing ciphertext. The first ciphertext may comprise a jump instruction indicating a specific address of the first memory 110, such as ‘0X0’, and the second ciphertext is a short but essential predefined function, such as hardware initiation instructions. FIG. 4 is a schematic diagram illustrating an embodiment of the memories. Referring to FIGS. 3 and 4, the boot method of the invention follows.

At first, a device boots from the boot ROM (BR). In step S302, a checksum of the content in the first memory 10 is calculated, and in step S304, the calculated checksum is encrypted by the security engine 140 to obtain the calculated checksum in ciphertext, and is stored at address ‘C’ of the second memory 120. In step S306, the calculated checksum in ciphertext is compared with the pre-calculated checksum in ciphertext pre-stored in the first memory 110. If the checksums do not match (No in step S308), the procedure is terminated.

If matched (Yes in step S308), in step S310, the first ciphertext (ciphertext A) is decrypted to obtain a first plain text (plain text A), and in step S312, the first plain text (plain text A) is stored at address ‘A’ of the second memory 120. It is understood that the first ciphertext (ciphertext A) is decrypted by the security engine 140 using the parameters 150, especially including a chip ID. Additionally, the instruction for decrypting the first ciphertext (ciphertext A) is defined in the boot ROM.

At the end of the boot ROM, in step S318, the first plain text (plain text A) at address ‘A’ is executed. In step S319, it is determined whether the execution of the first plain text (plain text A) is successful or failed. In some embodiments, it can be determined whether the first plain text comprises a jump instruction of a first specific address of the first memory before the execution of the first plain text. If not, a boot procedure of the device is terminated. If the execution fails (not correctly jump to a specific address such as ‘0X0’ in first memory 110), the procedure is terminated. If the execution is successful, in step S320, the second ciphertext (ciphertext B) is decrypted to generate a second plain text (plain text B), and in step S322, the second plain text (plain text B) is stored at address ‘B’ of the second memory 120. It is noted that the decryption of the second ciphertext (ciphertext B) may be executed right away the jumping to ‘0X0’ in first memory 110, or after some other operations or functions executed prior thereto. It is understood that since the original first plain text is encrypted using parameters that same as the parameters 150, the first plain text (plain text A) can be correctly obtained using the same parameters in decryption. If the parameters in decryption and encryption are not matched, the decryption result may not be the same as the original plain text. In this embodiment, if the parameters 150, especially including the chip ID, in decryption do not match that the parameters used in encryption, the instruction decrypted onto address ‘A’ should not be ‘jump 0X0’, and steps S320 and S322 cannot be executed, resulting in boot failure. Additionally, since decryption of ciphertext A and execution of plain text A at address ‘A’ are defined in the boot ROM, the verification process cannot be skipped.

In step S324, the second plain text (plain text B) at address ‘B’ is executed. As described, the second plain text may be an instruction for initiating hardware. After the execution of the second plain text (plain text B), in step S326, a boot procedure of the device at address ‘D’ of the first memory 110 is executed and proceeded with, in which the second plain text (plain text B) comprises a return instruction indicating address ‘D’. Since the original second plain text is encrypted using parameters the same as the parameters 150 in encryption, the second plain text (plain text B) can be correctly obtained using the same parameters in decryption. If the parameters in decryption and encryption are not matched, the decryption result may not be the same as the original plain text. In this embodiment, if the parameters 150, especially including the chip ID, in decryption do not match that the parameters used in encryption, the instruction decrypted onto address ‘B’ is not expected. For example, the instruction decrypted onto address ‘B’ may be meaningless codes. Consequently, step S326 cannot be executed, resulting in boot failure. Since the second ciphertext is a short but essential predefined function, the boot procedure may fail if the execution of second plain text is skipped.

It is understood that, in some embodiments, the ciphertexts A and B can be independently existed in the first memory.

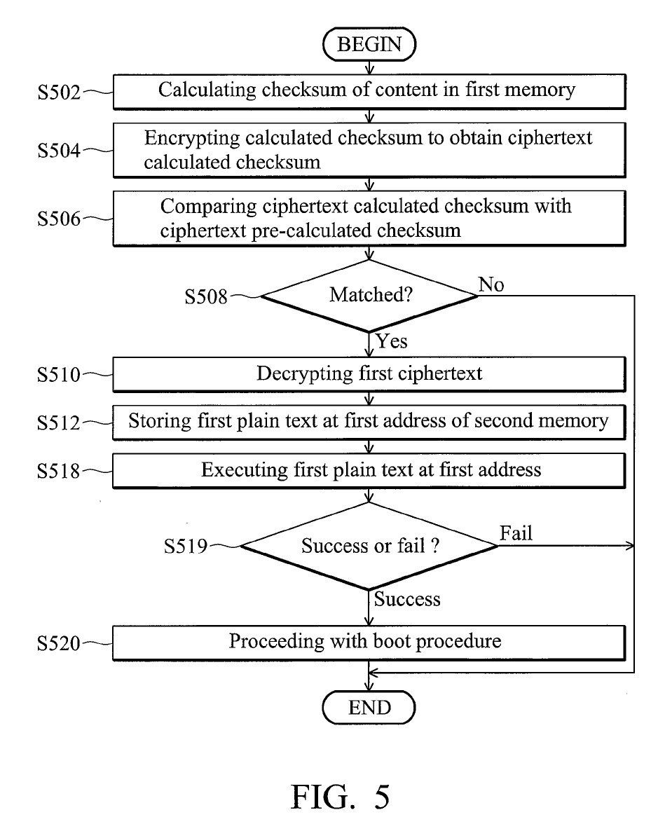

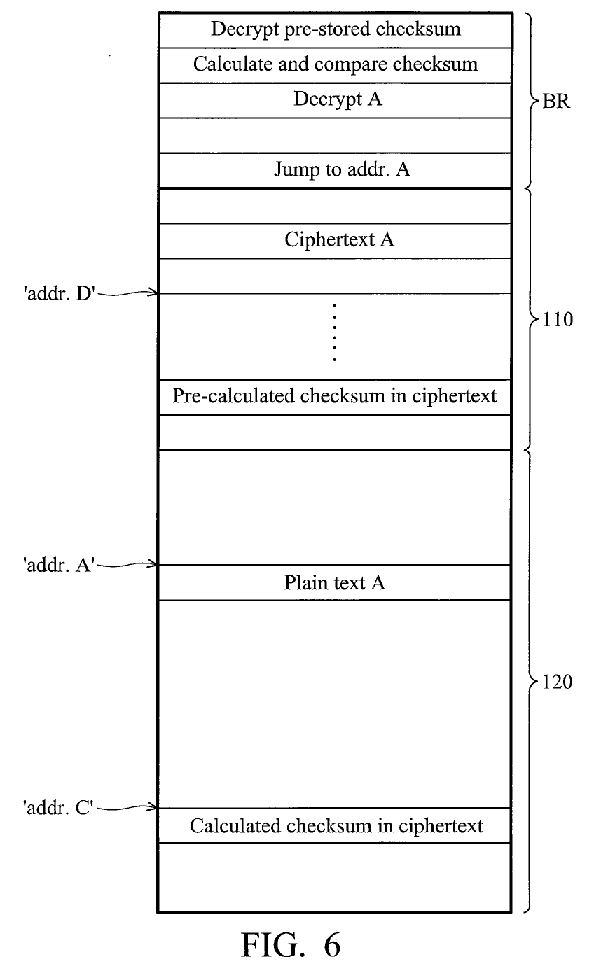

FIG. 5 is a flowchart of another embodiment of a boot method, in which the first ciphertext and the pre-calculated checksum in ciphertext are stored to the first memory in the factory line via the mentioned method for storing ciphertext. The first ciphertext may comprise a jump instruction. FIG. 6 is a schematic diagram illustrating an embodiment of the memories. Referring to FIGS. 5 and 6, the boot method of the invention follows.

At first, a device boots from the boot ROM (BR). In step S502, a checksum of the content in the first memory 10 is calculated, and in step S504, the calculated checksum is encrypted by the security engine 140 to obtain the calculated checksum in ciphertext, and is stored at address ‘C’ of the second memory 120. In step S506, the calculated checksum in ciphertext is compared with the pre-calculated checksum in ciphertext pre-stored in the first memory 110. If the checksums do not match (No in step S508), the procedure is terminated. If matched (Yes in step S508), in step S510, the first ciphertext (ciphertext A) is decrypted to obtain a first plain text (plain text A), and in step S512, the first plain text (plain text A) is stored at address ‘A’ of the second memory 120. It is understood that the first ciphertext (ciphertext A) is decrypted by the security engine 140 using the parameters 150, especially including a chip ID. Additionally, the instruction for decrypting the first ciphertext (ciphertext A) is defined in the boot ROM. At the end of the boot ROM, in step S518, the first plain text (plain text A) at address ‘A’ is executed. In step S519, it is determined whether the execution of the first plain text (plain text A) is successful or failed. If the execution fails (not correctly jump to a specific address in first memory 110), the procedure is terminated. If the execution is successful, in step S520, a boot procedure of the device at the specific address, such as address ‘D’ of the first memory 110 is executed and proceeded with.

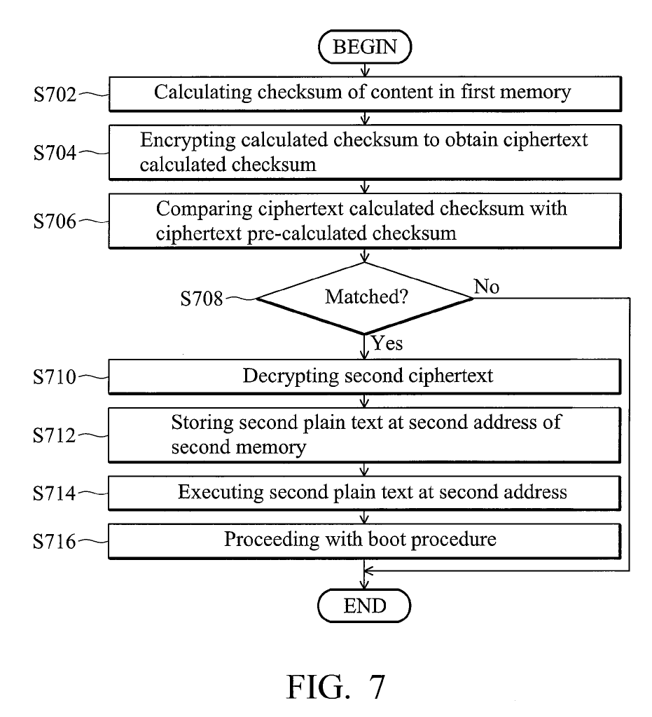

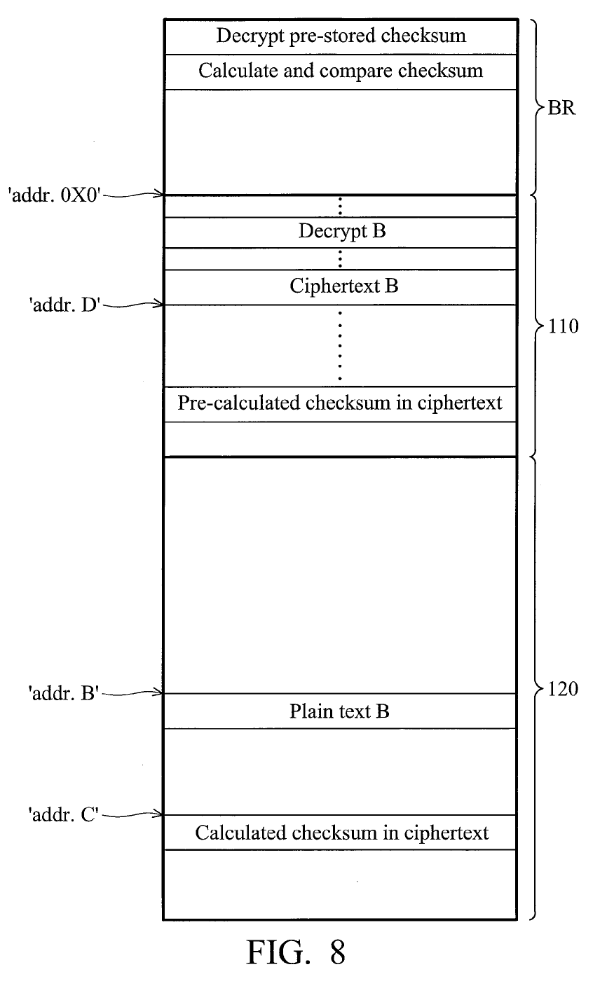

FIG. 7 is a flowchart of still another embodiment of a boot method, in which the second ciphertext and the pre-calculated checksum in ciphertext are stored to the first memory in the factory line via the mentioned method for storing ciphertext. The second ciphertext is a short but essential predefined function, such as hardware initiation instructions. FIG. 8 is a schematic diagram illustrating an embodiment of the memories. Referring to FIGS. 7 and 8, the boot method of the invention follows.

At first, a device boots from the boot ROM (BR). In step S702, a checksum of the content in the first memory 10 is calculated, and in step S704, the calculated checksum is encrypted by the security engine 140 to obtain the calculated checksum in ciphertext, and is stored at address ‘C’ of the second memory 120. In step S706, the calculated checksum in ciphertext is compared with the pre-calculated checksum in ciphertext pre-stored in the first memory 110. If the checksums do not match (No in step S708), the procedure is terminated. If matched (Yes in step S708), in step S710, the second ciphertext (ciphertext B) is decrypted to generate a second plain text (plain text B), and in step S712, the second plain text (plain text B) is stored at address ‘B’ of the second memory 120. As shown in FIG. 8, the instruction for decrypting ciphertext B is defined in the first memory 10, however, it is not limited thereto, the instruction for decrypting ciphertext B can be defined in the boot ROM. In step S714, the second plain text (plain text B) at address ‘B’ is executed. As described, the second plain text may be an instruction for initiating hardware. After the execution of the second plain text (plain text B), in step S716, a boot procedure of the device at address ‘D’ of the first memory 10 is executed and proceeded with, in which the second plain text (plain text B) comprises a return instruction indicating address ‘D’.

Boot systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A boot system for use in a device, comprising:
a first memory comprising first ciphertext; and
a processing unit decrypting the first ciphertext to generate a first plain text, determining whether the first plain text comprises a jump instruction of a first specific address of the first memory, and if not, terminating a boot procedure of the device.

2. The system of claim 1, wherein, if the first plain text comprises a jump instruction of a first specific address of the first memory, the processing unit further stores the first plain text at a first address of second memory, executes the first plain text at the first address, decrypts a second ciphertext in the first memory to generate a second plain text, stores the second plain text at a second address of the second memory, executes the second plain text at the second address, and proceeds with the boot procedure of the device after the execution of the second plain text.

3. The system of claim 2 wherein the processing unit further uses a security engine to decrypt the first and second ciphertext according to identification comprising a chip ID of the device.

4. The system of claim 2 wherein an original plain text of a security ID is encrypted during a build process, the encrypted security ID is decrypted to obtain a first plain text of the security ID in a factory line, it is determined whether the first plain text of the security ID matches a second plain text of the security ID loaded from a registry or key-pro, which is the same as the original plain text of the security ID, and if matched, the first ciphertext/second ciphertext is stored to the first memory.

5. The system of claim 2 wherein the first memory is a flash memory, and the second memory is a RAM (random access memory).

6. The system of claim 1 wherein the decryption of the first ciphertext is in response to an instruction defined in boot ROM (read only memory) of the device.

7. The system of claim 2 wherein the second plain text comprises instructions for initiating hardware of the device.

8. The system of claim 1 wherein the processing unit further calculates a checksum for the first memory, uses a security engine to encrypt the calculated checksum in ciphertext, and compares the calculated checksum in ciphertext with a pre-calculated checksum in ciphertext pre-stored in the first memory.

9. A boot method for use in a device, comprising:
decrypting a first ciphertext in first memory to generate a first plain text;
determining whether the first plain text comprises a jump instruction of a first specific address of the first memory; and
if not, terminating a boot procedure of the device.

10. The method of claim 9 further comprising:
if the first plain text comprises a jump instruction of a first specific address of the first memory, storing the first plain text at a first address of second memory;
executing the first plain text at the first address;
decrypting a second ciphertext in the first memory to generate a second plain text;
storing the second plain text at a second address of the second memory;
executing the second plain text at the second address; and
proceeding with the boot procedure of the device after the execution of the second plain text.

11. The method of claim 10 further comprising decrypting the first and second ciphertext according to identification comprising a chip ID of the device.

12. The method of claim 10 further comprising encrypting an original plain text of a security ID during a build process, decrypting the encrypted security ID to obtain a first plain text of the security ID in a factory line, determining whether the first plain text of the security ID matches a second plain text of the security ID loaded from a registry or key-pro, which is the same as the original plain text of the security ID, and if matched, storing the first and second ciphertexts to the first memory.

13. The method of claim 10 wherein the first memory is a flash memory, and the second memory is a RAM (random access memory).

14. The method of claim 9 further comprising decrypting the first ciphertext in response to an instruction defined in boot ROM (read only memory) of the device.

15. The method of claim 10 wherein the second plain text comprises instructions for initiating hardware of the device.

16. The method of claim 9 further comprising calculating a checksum for the first memory, encrypting the calculated checksum in ciphertext, and comparing the calculated checksum in ciphertext with a pre-calculated checksum in ciphertext pre-stored in the first memory.

17. A boot system for use in a device, comprising:
a first memory comprising second ciphertext;
a second memory; and
a processing unit decrypting the second ciphertext in the first memory to generate a second plain text, storing the second plain text at a second address of the second memory, executing the second plain text at the second address, and proceeding with a boot procedure of the device after the execution of the second plain text.

18. The system of claim 17 wherein the processing unit further decrypts first ciphertext in the first memory to generate a first plain text comprising a jump instruction of a first specific address of the first memory, stores the first plain text at a first address of the second memory, executes the first plain text at the first address, and the decryption of the second ciphertext is executed after the execution of the first plain text.

19. The system of claim 17 wherein the processing unit further calculates a checksum for the first memory, uses a security engine to encrypt the calculated checksum in ciphertext, and compares the calculated checksum in ciphertext with a pre-calculated checksum in ciphertext pre-stored in the first memory.

20. The system of claim 18 wherein the processing unit further uses a security engine to decrypt the first and second ciphertexts according to identification comprising a chip ID of the device.

21. The system of claim 17 wherein the second plain text comprises instructions for initiating hardware of the device.

22. A boot method for use in a device, comprising:
decrypting second ciphertext in first memory to generate a second plain text;
storing the second plain text at a second address of second memory;
executing the second plain text at the second address; and
proceeding with a boot procedure of the device after the execution of the second plain text.

23. The method of claim 22 further comprising decrypting first ciphertext in the first memory to generate a first plain text comprising a jump instruction of a first specific address of the first memory, storing the first plain text at a first address of the second memory, executing the first plain text at the first address, and the decryption of the second ciphertext is executed after the execution of the first plain text.

24. The method of claim 22 further comprising calculating a checksum for the first memory, encrypting the calculated checksum in ciphertext, and comparing the calculated checksum in ciphertext with a pre-calculated checksum in ciphertext pre-stored in the first memory.

25. The method of claim 23 further comprising decrypting the first/second ciphertext according to identification comprising a chip ID of the device.

26. The method of claim 22 wherein the second plain text comprises instructions for initiating hardware of the device.

27. A boot system for use in a device, comprising:
a first memory comprising first and second ciphertext;
second memory; and
a processing unit decrypting the first ciphertext to generate a first plain text comprising a jump instruction of a first specific address of the first memory, storing the first plain text at a first address of the second memory, executing the first plain text at the first address, decrypting the second ciphertext to generate a second plain text, storing the second plain text at a second address of the second memory, executing the second plain text at the second address, and proceeding with a boot procedure of the device after the execution of the second plain text.

28. A boot method for use in a device, comprising:
decrypting a first ciphertext in first memory to generate a first plain text comprising a jump instruction of a first specific address of the first memory;
storing the first plain text at a first address of second memory;
executing the first plain text at the first address;
decrypting a second ciphertext in the first memory to generate a second plain text;
storing the second plain text at a second address of the second memory;
executing the second plain text at the second address; and
proceeding with a boot procedure of the device after the execution of the second plain text.
